(19) United States
(12) Patent Application Publication
(10) Pub. No.: US 2005/0281045 A1
(43) Pub. Date: Dec. 22, 2005

(54) ADJUSTED STRUCTURE OF DISCHARGE HEADLIGHT

(76) Inventor: Jung-Tsung Yang, Hsin Chu (TW)

Correspondence Address: BACON & THOMAS, PLLC, 625 SLATERS LANE, FOURTH FLOOR, ALEXANDRIA, VA, 22314, US

(21) Appl. No.: 10/872,424

(22) Filed: Jun. 22, 2004

(51) Int. Cl. F21V 19/02

(52) U.S. Cl. 362/526; 362/523; 362/549

(57) ABSTRACT

An adjusted structure of discharge headlight according to the invention, which is a vehicle discharge headlight having a function of switching between high beam and low beam, includes at least a base containing a solenoid valve and a sliding lamp holder. The said lamp holder is a holder for holding lamp and is actuated by the solenoid valve, such that the lamp holder and the lamp can accordingly move along the sliding slot inside the base, in order to change the reflecting angle of beam inside lamp shade, and thereby to switch between high beam and low beam. Thus, the deficiency of current discharge headlight, which is unable to vary radiation distance, is ameliorated.

### BACKGROUND OF THE INVENTION

(a) Field of the Invention

The invention relates to an adjusted structure of discharge headlight, and more particularly, to a vehicle headlight structure which can change the reflecting location of a lamp inside the lamp shade and accordingly affect the angle of reflection, thereby accomplishes the switching between high beam and low beam, Thus, the deficiency of current discharge headlight, which is unable to switch between high beam and low beam, is ameliorated.

(b) Description of the Prior Art

Lately, to ensure the road safety and the driving comfort, many automobile manufacturers has successively adopted HID gaseous discharge headlight as the necessary equipment. In an H.I.D (High Intensity Discharge) gaseous discharge headlight, the crystal tube was filled with Xenon, a sophisticated ballast is then used to instantly raise the voltage from 12 volts to 23000 volts, after Xenon being excited and accordingly ionized, a beam of high intensity arc is thus formed between two electrodes. As HID provides higher radiation intensity and broader radiation range, it is quite beneficial to those who frequently drive at night time or those who drive through the road without appropriate lighting.

However, HID gaseous discharge headlight is constrained by that the beam are radiated at a fixed distance. It is unable to switch between high beam and low beam as conventional halogen lamp does. Consequently, when two vehicles meets on the road, HID gaseous discharge headlight often irradiate to the driver at the opposite vehicle and the vision persistence of the driver at the opposite vehicle caused by the irradiation will degrade the ability of correctly identifying the status of the road, which may then cause a disaster. Therefore, properly adjusting the light source and radiation distance of a discharge headlight has become one of the researches to be devoted and one the most imperative problems that the manufacturers have to solve.

### SUMMARY OF THE INVENTION

The primary object of the invention is to provide a discharge headlight structure, which has a solenoid valve for moving a sliding lamp holder and a lamp forwards or backwards, such that the reflecting location of the lamp inside the lamp shade is changeable and the irradiating angle of beam is affected accordingly, thereby accomplishes the switching between high beam and low beam, and thus ameliorates the deficiency of current discharge headlight, which is unable to change the radiation distance.

The detailed descriptions as well as the technical contents of the invention shall be given with the accompanying drawings hereunder.

### BRIEF DESCRIPTION OF THE DRAWINGS

FIG. 1 shows an elevational view according to the invention.

FIG. 2 shows an exploded elevational view according to the invention.

FIG. 3 shows a side view according to the invention.

FIG. 4 shows a sectional view along A-A according to the invention.

FIG. 5 shows a sectional view of the solenoid valve at withdrawal state according to the invention.

FIG. 6 shows a sectional view of the solenoid valve at withdrawal state according to the invention.

FIG. 7 shows the operation of the solenoid valve according to the invention.

### DETAILED DESCRIPTION OF THE PREFERRED EMBODIMENTS

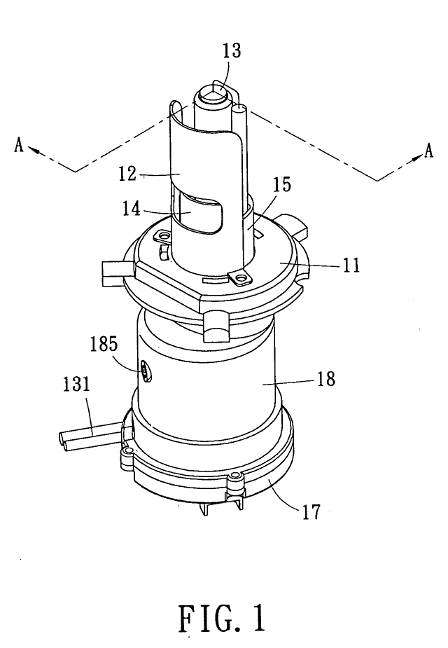

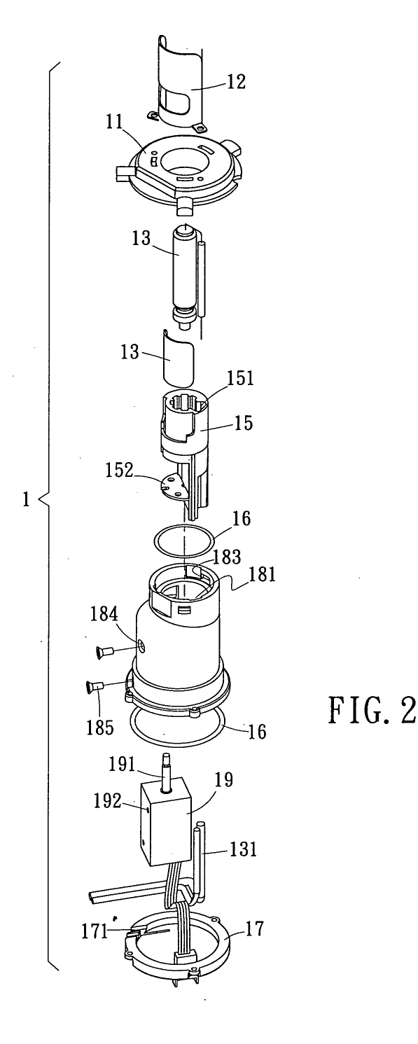

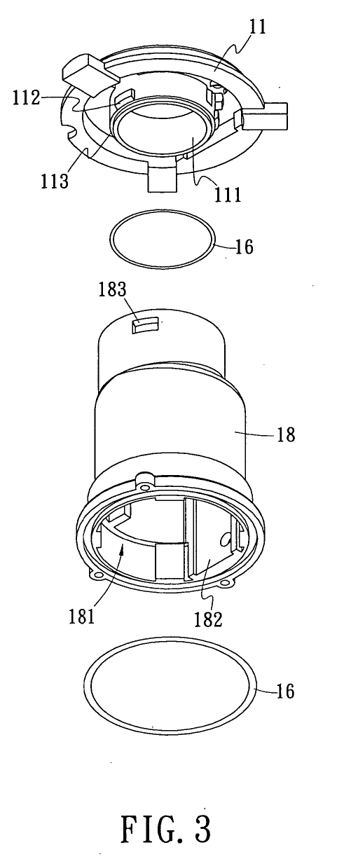

Firstly, referring to FIG. 1, FIG. 2 and FIG. 3, a discharge headlight 1 according to the invention primarily comprises an upper cover 11, a long mask 12, a short mask 14, a lamp 13, a lamp holder 15, an O-ring 16, a base 18, a solenoid valve 19, and a lower cover 17. The interior of the containing slot 181 at the base 18 is disposed with a sliding slot 182 for fitting the lamp holder 15. The top of the lamp holder 15 is disposed with multiple slots 151 for adapting the lamp 13 and the conductors 131, and at its side part a short mask 14 is provided for masking light source; further at the bottom of the lamp holder 15 is provided with a brake pad 152, the said brake pad 152 is used for fixing the extension rod 191 of the solenoid valve 19. The solenoid valve 19 has a lock hole 192, which is correspondent to the via 184 of the base 18, such that a screw 185 can fix the solenoid valve 19 onto the base 18. Therefore, when the solenoid valve 19 is active, through the control of extension rod 191, the lamp base 15 and the lamp 13 as well as the short mask 14 can move forwards and backwards such that the displacement of the light source of the lamp 13 is adjustable.

Additionally, the interior of the said base 18 is provided with a lamp holder 15 and a solenoid valve 19. The lamp holder 15 is fitted with a short mask 14, a lamp 13, conductors 131, and a brake pad 152, which are sealed by an O-ring 16 and a lower cover 17. The said lower cover 17 is provided with penetrating slot 171 for allowing conductors 131 passing through

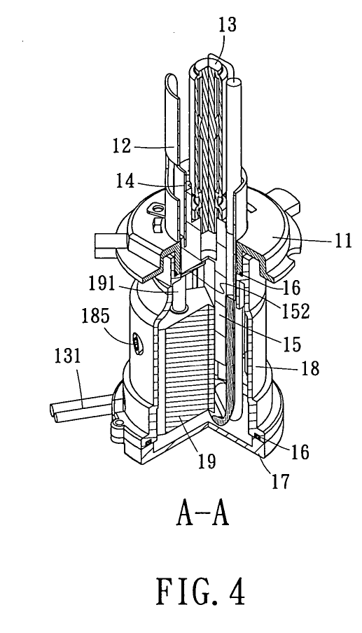

Further, an upper cover 11 is covered on the top of the base 18. On the upper side of the said upper cover 11, a long mask 12 is provided. The long mask 12 and the short mask 14 are integrally formed by pressing and shearing, then they are bended and encircled around the lamp 13 to protect the lamp 13 and mask the light source such that the rays provided by the lamp 13 are radiated toward the same direction. Further, at the center of the upper cover 11 a ring body 111 is formed. The periphery surrounding the opening of the said ring body 111 is provided with a ring slot 113 for installing O-ring 16, which will form a water-proof structure when combined with the base 18. Besides, a lock part 112 is provided at the periphery of the ring body 111. The said lock part 112 is correspondent to the lock slot 183 of the base 18 in order to form an operation of turn-and-lock, as shown in FIG. 4.

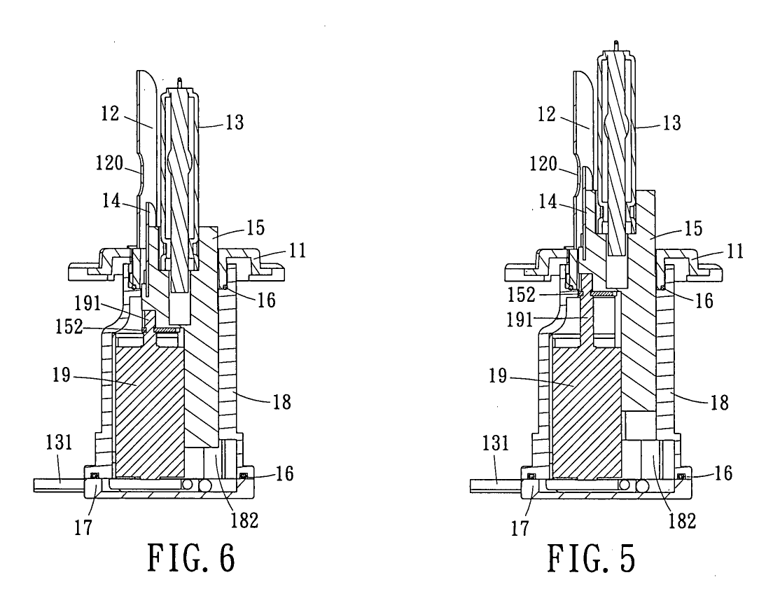

Referring to FIG. 5 and FIG. 6, in which the solenoid valve 19 is fixed by the brake pad 152 of the lamp holder 15 and the extension rod 191. The said solenoid valve 19 is primarily an actuating element for enabling displacement. Also, it allows instant locating and instant power-off after locating. Although this invention takes solenoid valve 19 as a preferred embodiment, it is possible to take other elements, such as stepping motor or servo motor, as another embodiment.

When the extension rod 191 of the solenoid valve 19 is withdrawn, the lamp holder 15 is accordingly withdrawn along the sliding slot 182. As a result, the light source of the lamp 13 is moved backwards. In the mean while, part of the beam is radiated through the hollow 120, and then radiated out after being reflected by the lamp shade (not shown) of the headlight. Because the angle of reflection is narrow after the light source being moved backwards, the distance of radiation is near, which forms the status of low beam; on the other hand, when the solenoid valve 19 is active, the extension rod 191 is extended, accordingly, the lamp holder 15 is pushed forwards and the lamp 13 is moved forwards, the light source of the lamp 13 will be accordingly moved forwards. As the beam radiated to the lamp shade is reflected with broader angle of reflection, the beam will be radiated to farther distance, which forms the status of high beam.

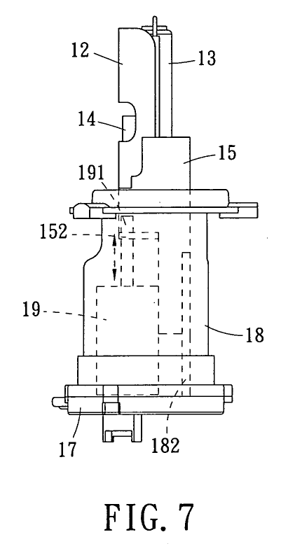

Corresponding to the explanation described above, FIG. 7 demonstrates the operation performed by the adjusted structure of the discharge headlight according to the invention. As the HID discharge headlight is a type of single-point light source, it is unable to switch between high beam and low beam as conventional halogen headlight does. Since the switching between high beam and low beam is dependent on the angle of reflection that light source radiates to the lamp shade, this invention thus utilizes a solenoid valve 19 to control a sliding lamp holder 15 and a lamp 13 as well as a short mask 14, such that they can be moved forwards or backward in order to vary the reflecting location of the lamp 13 inside the lamp shade and thus affect the radiation distance as well as the radiation angle. Consequently, the switching between high beam and low beam becomes feasible. Therefore, the deficiency of current discharge headlight in terms of unchangeable radiation distance is ameliorated,

1. An adjustable structure of discharge headlight, which is a vehicle discharge headlight provided with the function of high/low beam switching, at least includes:
an upper cover, which provides a long mask at the top, and provides a ring body at the center with an O-ring fitted at the said ring body, and a lock part is formed at the periphery of the said ring body for locking to the base;
a base, which is a hollow container for containing a solenoid and a lamp holder, wherein a sliding slot is provided at the interior wall of the base for guiding the displacement of the lamp holder, a lock slot is provided at the top of the base for setting up to the upper cover, and a lower cover is provided at the bottom of the base for sealing;
a lamp holder, which provides slot for fitting lamp and conductors, and a short mask is fitted at one side of the lamp holder, a brake pad is provided at the lower side of the lamp holder for fixing the extension rod of the solenoid valve;
a solenoid valve, which is a control element driven by current, the extension rod of which is fixed to the lamp holder for actuating the displacement of the lamp holder, the lamp, and the short mask;
a lower cover, which is enveloped at the bottom of the base;
to the effect that, under the control of the solenoid valve, the lamp holder, the lamp, and the short mask is able to move forwards and backwards, and the reflecting location of the lamp becomes variable, which further affect the radiation distance as well as the radiation angle in order to enable the switching between high beam and low beam, the deficiency of current discharge headlight in terms of unchangeable radiation distance is thus ameliorated.

2. The adjusted structure of discharge headlight in accordance with claim 1, wherein the O-ring fitted to the ring body of the upper cover is made of water-proof material for preventing water from penetrating into the base and the lamp.

3. The adjusted structure of discharge headlight in accordance with claim 1, wherein the solenoid valve can be replaced and embodied by a stepping motor or a servo motor which likewise enables the displacement of the lamp holder, the lamp, and the short mask.
